(19) United States
(12) Patent Application Publication
(10) Pub. No.: US 2026/0017979 A1
(43) Pub. Date: Jan. 15, 2026

(54) IDENTITY VERIFICATION

(71) Applicant: Tencent Technology (Shenzhen) Company Limited, Shenzhen (CN)

(72) Inventors: Xiaojie CHEN, Shenzhen (CN); Jun WANG, Shenzhen (CN); Shaoming WANG, Shenzhen (CN); Runzeng GUO, Shenzhen (CN); Jinkun HOU, Shenzhen (CN); Yingyi ZHANG, Shenzhen (CN); Ruixin ZHANG, Shenzhen (CN)

(73) Assignee: Tencent Technology (Shenzhen) Company Limited, Shenzhen (CN)

(21) Appl. No.: 19/331,986

(22) Filed: Sep. 17, 2025

Related U.S. Application Data
(63) Continuation of application No. PCT/CN2024/092329, filed on May 10, 2024.

(30) Foreign Application Priority Data
Jun. 25, 2023 (CN) 202310754481.4

(51) Int. Cl. G06V 40/12; G06Q 20/40; G06V 10/25; G06V 10/26; G06V 10/44; G06V 10/776; G06V 40/13

(52) U.S. Cl. CPC G06V 40/1365; G06Q 20/4014; G06V 10/25; G06V 10/26; G06V 10/44; G06V 10/776; G06V 40/1347; G06V 40/1318

(57) ABSTRACT

One or more palm images are captured based on a preset capturing field of view. Respective palm key points in the one or more palm images are detected. Respective palm directions of palms in the one or more palm images are determined according to the respective palm key points. Respective calibration directions of the preset capturing field of view are determined for the one or more palm images. Respective capturing angles in the one or more palm images are determined according to the respective palm directions of the palms in the one or more palm images and the respective calibration directions. From the one or more palm images, a target palm image whose capturing angle is within a preset capturing angle range is selected for an identity verification. The preset capturing angle range is set to avoid the target palm image being from an incorrect participant of the identity verification.

### RELATED APPLICATIONS

The present application is a continuation of International Application No. PCT/CN2024/092329, filed on May 10, 2024, which claims priority to Chinese Patent Application No. 202310754481.4, filed on Jun. 25, 2023. The entire disclosures of the prior applications are hereby incorporated by reference.

### FIELD OF THE TECHNOLOGY

This disclosure relates to computer technologies, including an identity verification method and apparatus, a device, and a medium.

### BACKGROUND OF THE DISCLOSURE

With the development of computer technologies, a palm verification payment technology emerges. The wide application of palm verification payment in daily life may provide people with more options and convenience in payment methods, and people can perform secure payment through palm verification.

In a palm verification payment scenario, the environment is usually relatively complex, and there are cases of incorrect determining during identity verification.

For example, in a real-world palm verification payment scenario, such as a convenience store or a supermarket, when a user has no intention to pay, accidental payment may occur because the user accidentally places a palm in a capturing field of view of a palm verification device.

### SUMMARY

According to various embodiments of this disclosure, an identity verification method and apparatus, a device, a medium are provided.

Some aspects of the disclosure provide a method for an identity verification. In some examples, one or more palm images are acquired, the one or more palm images are captured based on a preset capturing field of view. Respective palm key points in the one or more palm images are detected, palm key points in a palm image of the one or more palm images are key points associated with a palm in the palm image. Respective palm directions of palms in the one or more palm images are determined according to the respective palm key points associated with the palms in the one or more palm images. Respective calibration directions of the preset capturing field of view are determined for the one or more palm images. Respective capturing angles of the palms in the one or more palm images are determined according to the respective palm directions of the palms in the one or more palm images and the respective calibration directions. From the one or more palm images, a target palm image whose capturing angle is within a preset capturing angle range is selected. The preset capturing angle range is set to avoid the target palm image being from an incorrect participant of the identify verification. The identity verification is performed according to the target palm image.

Some aspects of the disclosure provide an apparatus that includes processing circuitry configured to perform the method for the identity verification.

Some aspects of the disclosure also provide a non-transitory computer-readable storage medium storing instructions which when executed by at least one processor cause the at least one processor to perform the method for the identity verification.

According to a first aspect, this disclosure provides an identity verification method, the method including: acquiring, in response to an identity verification trigger event, at least one palm image captured with a preset capturing field of view; detecting key points in each palm image to obtain respective palm key points of the each palm image; determining a palm direction of a palm in the each palm image respectively according to the respective palm key points of the each palm image; determining a preset calibration direction in the capturing field of view for the each palm image, and determining a capturing angle of the palm in the palm image according to an angle between the palm direction of the palm in the palm image and the calibration direction; selecting, from the at least one palm image, a palm image whose capturing angle is within a preset capturing angle range to obtain a target palm image; and performing identity verification according to the target palm image.

According to a second aspect, this disclosure provides an identity verification apparatus, the apparatus including: an acquisition module, configured to acquire, in response to an identity verification trigger event, at least one palm image captured with a preset capturing field of view; a detection module, configured to detect key points in each palm image to obtain respective palm key points of the each palm image; a determining module, configured to determine a palm direction of a palm in the each palm image respectively according to the respective palm key points of the each palm image; and determine a preset calibration direction in the capturing field of view for the each palm image, and determine a capturing angle of the palm in the palm image according to an angle between the palm direction of the palm in the palm image and the calibration direction; a screening module, configured to select, from the at least one palm image, a palm image whose capturing angle is within a preset capturing angle range to obtain a target palm image; an identity verification module, configured to perform identity verification according to the target palm image.

According to a third aspect, this disclosure provides a computer device, including a memory and a processor (an example of processing circuitry), the memory having a computer program stored therein, and the processor executing the computer program to implement the operations in the method embodiments of this disclosure.

According to a fourth aspect, this disclosure provides a computer-readable storage medium (e.g., non-transitory computer-readable storage medium), having a computer program stored therein, the computer program being executed by a processor to implement the operations in the method embodiments of this disclosure.

According to a fifth aspect, this disclosure provides a computer program product, including a computer program, the computer program being executed by a processor to implement the operations in the method embodiments of this disclosure.

Details of one or more embodiments of this disclosure are provided in the accompanying drawings and descriptions below. Other features, objectives, and advantages of this disclosure become clear from the specification, the drawings, and the claims.

### BRIEF DESCRIPTION OF THE DRAWINGS

FIG. 1 is a diagram of an application environment of an identity verification method according to an embodiment.

FIG. 2 is a schematic flowchart of an identity verification method according to an embodiment.

FIG. 3 is a schematic diagram of palm key points detected from a palm image according to an embodiment.

FIG. 4 is a schematic diagram of accidental payment by a verification initiator according to an embodiment.

FIG. 5 is a schematic diagram of selecting a target palm image from palm images according to an embodiment.

FIG. 6 is a schematic diagram of palm image capturing and payment processes according to an embodiment.

FIG. 7 is a schematic diagram of a process for defining a calibration direction according to an embodiment.

FIG. 8 is a schematic diagram of a palm direction and a calibration direction for capturing of a left hand according to an embodiment.

FIG. 9 is a schematic diagram of a calculation process of a capturing angle for capturing of a left hand according to an embodiment.

FIG. 10 is a schematic diagram of a calculation process of a capturing angle for capturing of a left hand according to another embodiment.

FIG. 11 is a schematic diagram of a palm direction and a calibration direction for capturing of a right hand according to an embodiment.

FIG. 12 is a schematic diagram of a calculation process of a capturing angle for capturing of a right hand according to an embodiment.

FIG. 13 is a schematic diagram of a palm region box according to an embodiment.

FIG. 14 is a schematic diagram of a palm image obtained through cropping based on a palm region box according to an embodiment.

FIG. 15 is a schematic diagram of palm key points obtained by detecting a palm image obtained through cropping according to an embodiment.

FIG. 16 is a schematic flowchart of an identity verification method according to another embodiment.

FIG. 17 is a structural block diagram of an identity verification apparatus according to an embodiment.

FIG. 18 is a diagram of an internal structure of a computer device according to an embodiment.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

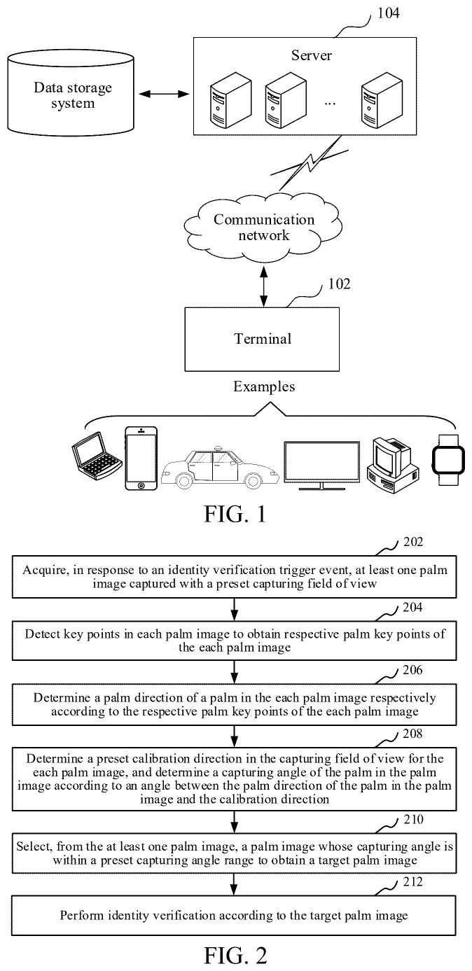

An identity verification method provided in this disclosure may be applied to an application environment shown in FIG. 1. In the figure, a terminal 102 communicates with a server 104 through a network. A data storage system may be provided separately, and may store data that the server 104 needs to process. The data storage system may be integrated on the server 104, or may be placed on cloud or other servers. The terminal 102 may be, but is not limited to, a palm verification device, various desktop computers, notebook computers, smartphones, tablet computers, Internet-of-things devices, and portable wearable devices. The Internet-of-things devices may be smart speakers, smart televisions, smart air conditioners, smart in-vehicle devices, and the like. The portable wearable devices may be smartwatches, smart bands, head-mounted devices, and the like. The server 104 may be an independent physical server, or may be a server cluster or a distributed system including a plurality of physical servers, or may be a cloud server providing basic cloud computing services, such as a cloud service, a cloud database, cloud computing, a cloud function, cloud storage, a network service, cloud communication, a middleware service, a domain name service, network security services such as cloud security or host security, a content delivery network (CDN), big data, and an artificial intelligence platform. The terminal 102 and the server 104 may be directly or indirectly connected in a wired or wireless communication protocol. This is not limited in this disclosure.

The terminal 102 may acquire, in response to an identity verification trigger event, at least one palm image captured with a preset capturing field of view. For each palm image, the terminal 102 may perform key point detection on the palm image to obtain palm key points. The terminal 102 may determine a palm direction of a palm in the each palm image respectively according to the respective palm key points of the each palm image, determine a preset calibration direction in the capturing field of view for the each palm image, and determine a capturing angle of the palm in the palm image according to an angle between the palm direction of the palm in the palm image and the calibration direction. Then, the terminal 102 may select, from the at least one palm image, a palm image whose capturing angle is within a preset capturing angle range to obtain a target palm image; and perform identity verification according to the target palm image.

The terminal 102 may capture the palm image by using an image capturing unit deployed on the terminal. Further, the server 104 stores a palm image captured in advance by using the image capturing unit, and the terminal 102 may alternatively acquire the palm image from the server. This is not limited in this embodiment. The application scenario in FIG. 1 is merely illustrative and is not limited thereto.

In identity verification methods in some embodiments of this disclosure, an artificial intelligence technology is used. For example, the palm key points in this disclosure are obtained through detection by using the artificial intelligence technology. For easier understanding of artificial intelligence, the concept of artificial intelligence is now described. In some aspects, artificial intelligence involves a theory, a method, a technology, and an application system that use a digital computer or a machine controlled by the digital computer to simulate, extend, and expand human intelligence, perceive an environment, acquire knowledge, and use knowledge to obtain an optimal result. In other words, artificial intelligence is a comprehensive technology in computer science and attempts to understand the essence of intelligence and produce a new intelligent machine that can react in a manner similar to human intelligence. Artificial intelligence is to study design principles and implementation methods of various intelligent machines, to enable the machines to have functions of perception, reasoning, and decision-making. In this disclosure, key point detection for a palm image is implemented based on the artificial intelligence technology, which can improve accuracy of key point detection.

In an embodiment, as shown in FIG. 2, an identity verification method is provided. In this embodiment, description is provided by using an example in which the method is applied to the terminal 102 in FIG. 1. The terminal 102 may be a palm verification device. The method includes the following operations.

Operation 202: Acquire, in response to an identity verification trigger event, at least one palm image captured with a preset capturing field of view.

The identity verification trigger event is an event for triggering an identity verification action, and may be a payment triggering operation, an event of detecting that a physical palm exists in a capturing field of view, or identifying another scenario in which identity verification needs to be performed. The palm image is captured by the image capturing unit of the terminal. The capturing field of view is a range in which the terminal captures the palm image from an environment by using the image capturing unit of the terminal. For a terminal, a capturing field of view of an image capturing unit of the terminal is also fixed relative to the terminal. The terminal may be used fixedly or may be a mobile terminal. The image capturing unit is a hardware unit capable of capturing an image, and may be referred to as a camera. The palm image is an image including an image of a palm, and the palm in the palm image refers to an image of a palm formed by imaging a physical palm in the palm image.

In an embodiment, the image capturing unit is deployed on the terminal. When a user places a palm above the image capturing unit, the terminal may capture an image of the palm by using the image capturing unit, and directly use the captured image as the palm image.

In an embodiment, the terminal may be a palm verification device, and the image capturing unit may be a camera. When a user places a palm in a capturing field of view of the camera of the palm verification device, the terminal may capture an image of the palm by using the camera to obtain the palm image.

Operation 204: Detect key points in each palm image to obtain respective palm key points of the each palm image.

The key points are feature points marking a position of a palm in the palm image. If at least two key points are detected, the palm in the palm image can be positioned by using the at least two key points. The palm key point is a key point detected from the palm image. The palm key point may be in the palm or at an edge of the palm, and may be a finger gap point, a fingertip, or a center of the palm.

In some embodiments, a position of the palm key point in the palm image is fixed relative to the palm. When the position of the palm changes, the palm key point also changes with the change of the palm position. If the palm key point is a finger gap point, when the palm is in an open state or a contracted state, the position of the palm key point does not change.

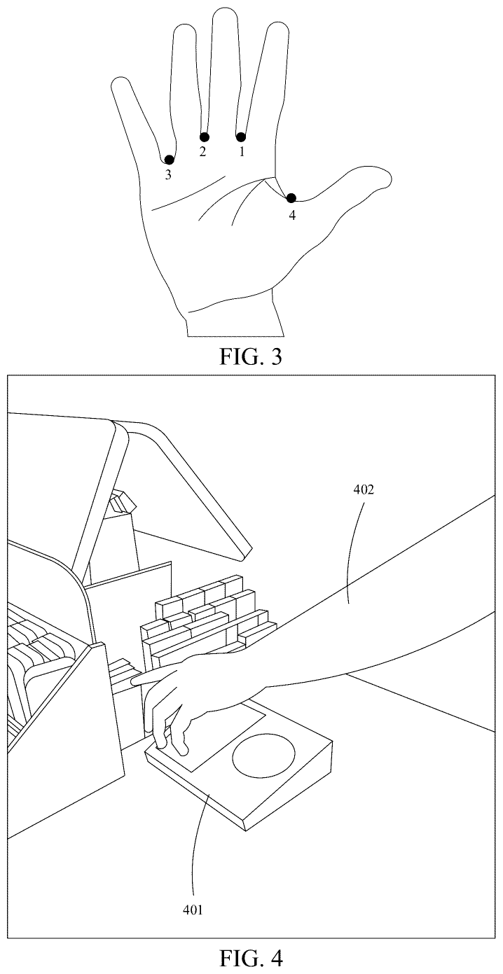

In an embodiment, the number of palm key points obtained through detection may be at least two. As shown in FIG. 3, after acquiring the palm image captured by the image capturing unit, the terminal may perform key point detection on the palm image, to obtain palm key points of the palm in the palm image, that is, a palm key point 1, a palm key point 2, a palm key point 3, and a palm key point 4.

In an embodiment, for each palm image, the terminal may input the palm image to a trained palm key point detection model, to perform key point detection on the palm image by using the palm key point detection model, and output palm key points of the palm in the palm image.

In an embodiment, the trained palm key point detection model may be obtained through training in the following manner: The terminal may acquire a training image including a palm. The training image carries a reference palm key point calibrated for the palm. The terminal may perform key point detection on the training image by using a to-be-trained palm key point detection model to obtain a predicted palm key point, and determine a loss value according to a position difference between the predicted palm key point and the reference palm key point. Then, the terminal may train the to-be-trained palm key point detection model by using the loss value, to obtain the trained palm key point detection model.

Operation 206: Determine a palm direction of a palm in the each palm image respectively according to the respective palm key points of the each palm image.

The palm direction can represent an orientation of the palm in the palm image. The palm direction may be represented in different manners. For example, the palm direction may be represented by using a direction pointing from the center of the palm to a particular fingertip of the palm, or may be represented by using a direction formed by two finger gap points. The two directions are different, but may both represent the palm direction.

In some aspects, there may be at least two palm key points obtained through detection. The terminal may determine the direction of the palm in the palm image according to the at least two palm key points obtained through detection to obtain the palm direction.

In an embodiment, the terminal may determine a palm shape according to the at least two palm key points obtained through detection, to determine the palm direction from the palm shape according to a predefined definition of the palm direction.

In an embodiment, the terminal may construct a vector according to the at least two palm key points obtained through detection, and use a direction of the constructed vector as the direction of the palm in the palm image to obtain the palm direction.

In an embodiment, the terminal may, for example randomly, select two palm key points from the palm key points obtained through detection, and construct a vector based on the two selected palm key points. Then, the terminal may use a direction of the constructed vector as the direction of the palm in the palm image to obtain the palm direction.

In an embodiment, the terminal may, for example randomly, select two palm key points from the palm key points obtained through detection, and use the two selected palm key points as a starting point and an end point of a vector to construct the vector. Then, the terminal may use a direction of the constructed vector as the direction of the palm in the palm image to obtain the palm direction.

Operation 208: Determine a preset calibration direction in the capturing field of view for the each palm image, and determine a capturing angle of the palm in the palm image according to an angle between the palm direction of the palm in the palm image and the calibration direction.

The calibration direction is a direction predefined for the image capturing unit. The capturing angle is a direction angle between the palm direction of the palm in the palm image and the calibration direction of the image capturing unit.

In an embodiment, the terminal may determine a direction angle between the palm direction and the calibration direction according to a difference between the palm direction and the calibration direction of the image capturing unit, and use the direction angle as the capturing angle of the palm in the palm image.

In an embodiment, the terminal may construct a vector along the palm direction, and construct a vector along the calibration direction of the image capturing unit. Then, the terminal may determine a direction angle between the palm direction and the calibration direction according to the vector constructed along the palm direction and the vector constructed along the calibration direction, and use the direction angle as the capturing angle of the palm in the palm image.

Operation 210: Select, from the at least one palm image, a palm image whose capturing angle is within a preset capturing angle range to obtain a target palm image.

In an embodiment, the terminal may select, from the at least one palm image obtained through capturing, a palm image whose capturing angle falls within a preset capturing angle range. There may be at least one selected palm image. The terminal may, for example randomly, select another palm image from the selected palm images as the target palm image.

In an embodiment, the terminal may preliminarily select, from the at least one palm image obtained through capturing, a palm image whose capturing angle falls within a preset capturing angle range. There may be at least one selected palm image. The terminal may perform image quality detection on each preliminarily selected palm image, and use a palm image having optimal quality as the target palm image. The image quality detection may be detecting at least one of completeness and definition of a palm.

In an embodiment, as shown in FIG. 4, in a palm verification payment scenario, the terminal may be a palm verification device 401. When a verification initiator 402 (which is a payee, for example, a cashier in a supermarket) uses a palm to indicate a payer (for example, a customer in the supermarket) to perform palm verification payment, the palm verification device may capture a palm image of the verification initiator 402, causing a case in which the verification initiator is incorrectly determined as the payer. The preset capturing angle range in this disclosure may be defined as a range of a capturing angle corresponding to a palm image captured for a party that is to perform payment. In this embodiment of this disclosure, a target palm image captured for the payer is selected from captured palm images based on the capturing angle, to avoid accidental payment by the verification initiator (who is not the payer, and thus is an incorrect participant of the identity verification for the payment) from a perspective of software, thereby reducing use costs of the palm verification device.

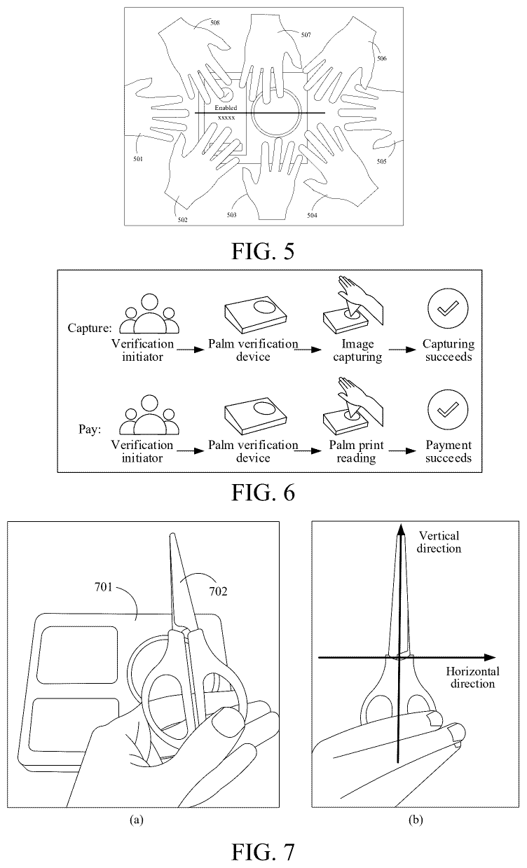

In an embodiment, in a palm verification payment scenario, the terminal is a palm verification device. As shown in FIG. 5, the palm verification device may select, from captured palm images (that is, eight palm images 501 to 508), palm images whose capturing angles fall within a preset capturing angle range (for example, capturing angles corresponding to five palm images 501 to 505 fall within a preset capturing angle range of 0° to 90°). The palm verification device may further (e.g., randomly) select a palm image from the selected five palm images as the target palm image (for example, 503 is the target palm image).

In an embodiment, in a palm verification payment scenario, the terminal is a palm verification device. As shown in FIG. 6, at an image capturing stage, after a verification initiator (for example, a cashier in a supermarket) initiates a payment invitation (for example, creates an order), the palm verification device may perform image capturing on a palm above the palm verification device to obtain at least one palm image. Then, the palm verification device may select a target palm image from the at least one palm image.

Operation 212: Perform identity verification according to the target palm image.

After determining the target palm image, the terminal may acquire biological information of a palm in the target palm image, and perform identity verification based on the biological information in the target palm image. If the identity verification fails, the payment may be abandoned. If the identity verification succeeds, a payment operation may be performed in response to the successful identity verification performed according to the biological information in the target palm image. The biological information may be at least one of a palm print, a palm shape, or color distribution on the palm.

During identity verification, in some examples, whether the palm in the target palm image is recorded in a database may be determined first. If not, the verification fails, or if yes, the verification succeeds. When the identity verification succeeds, a user to which the palm in the target palm image belongs may be further determined, to use an account of the user to perform the payment operation. In some aspects, during performing of the payment operation, order information may be acquired, and a payment amount is acquired from the order information, to perform the payment operation according to the payment amount.

In the foregoing identity verification method, at least one palm image captured with a preset capturing field of view is acquired in response to an identity verification trigger event, and key points are detected in each palm image to obtain respective palm key points of the each palm image. A palm direction of a palm in the each palm image is determined respectively according to the respective palm key points of the each palm image, a preset calibration direction in the capturing field of view is determined for the each palm image, and a capturing angle of the palm in the palm image is determined according to an angle between the palm direction of the palm in the palm image and the calibration direction. In this way, a palm image whose capturing angle falls within a preset capturing angle range for representing a party that is to perform payment is automatically selected from the at least one palm image, to obtain a target palm image, and identity verification is performed based on the target palm image. In a controllable way, verification can be correctly performed only when the palm is verified in a particular direction, thereby avoiding a case of incorrect determining.

When the identity verification method is applied to a palm verification payment scenario, compared with a related method in which a physical barrier is added beside a palm verification device to physically avoid accidental payment by a verification initiator, in this disclosure, palm key point detection is performed on captured palm images, a capturing angle of a palm is automatically determined based on detected palm key points, and a target palm image for palm verification payment is selected from the captured palm images based on the capturing angle, to avoid accidental payment by a verification initiator at a software level, thereby reducing use costs of the palm verification device.

In an embodiment, the determining a palm direction of a palm in the each palm image respectively according to the respective palm key points of the each palm image includes: constructing, for the each palm image if the palm key points of the palm image include a first palm key point and a second palm key point, a first vector according to the first palm key point and the second palm key point, and using a direction of the first vector as the palm direction of the palm in the palm image.

For a palm image, there are at least two palm key points of the palm image, including at least a first palm key point and a second palm key point. The first vector is a vector constructed based on the first palm key point and the second palm key point.

In some aspects, the terminal may use either of the first palm key point and the second palm key point as a starting point of the first vector, and construct the first vector according to the first palm key point and the second palm key point. The first vector passes through the first palm key point and the second palm key point. The terminal may use the direction of the first vector as a direction of the palm in the palm image to obtain the palm direction.

In this embodiment, the first vector is constructed by using the first palm key point and the second palm key point, and the direction of the first vector is used as the palm direction. In this way, calculation is simple, and the palm direction can be efficiently determined, thereby implementing efficient identity verification.

In an embodiment, the terminal may use either of the first palm key point and the second palm key point as the starting point of the first vector, and use a key point that is in the first palm key point and the second palm key point and that is not used as the starting point of the first vector as an end point of the first vector, to construct the first vector. A norm of the first vector is a length of a line segment between the first palm key point and the second palm key point. For example, if the terminal uses the first palm key point as the starting point of the first vector, the second palm key point may be used as the end point of the first vector, to construct the first vector. If the terminal uses the second palm key point as the starting point of the first vector, the first palm key point may be used as the end point of the first vector, to construct the first vector.

In an embodiment, the terminal may use either of the first palm key point and the second palm key point as the starting point of the first vector, and use a key point that is in the first palm key point and the second palm key point and that is not used as the starting point of the first vector as a point that the first vector is to pass through, to construct the first vector. A norm of the first vector is greater than a length of a line segment between the first palm key point and the second palm key point.

In an embodiment, the terminal may use either of the first palm key point and the second palm key point as the starting point of the first vector, and use a direction of a key point that is in the first palm key point and the second palm key point and that is not used as the starting point of the first vector as the direction of the first vector, to construct the first vector. The first vector does not pass through the second palm key point, and a norm of the first vector is less than a length of a line segment between the first palm key point and the second palm key point.

In an embodiment, the determining a preset calibration direction in the capturing field of view for the each palm image, and determining a capturing angle of the palm in the palm image according to an angle between the palm direction of the palm in the palm image and the calibration direction includes: constructing, for the each palm image if the palm key points of the palm image include a first palm key point and a second palm key point, a second vector along a horizontal direction by using the first palm key point or the second palm key point as a starting point, and using a direction of the second vector as the preset calibration direction in the capturing field of view.

Either the first palm key point or the second palm key point may be used as the starting point of the second vector. The terminal may use the starting point of the first vector as a new starting point to construct the second vector along the horizontal direction, and use the direction of the second vector as a preset calibration direction for a current palm image in the capturing field of view.

In an embodiment, as shown in part (a) in FIG. 7, scissors 702 are placed exactly above an image capturing unit of a terminal 701, and in this case, the horizontal direction in this disclosure may be defined as a direction shown in part (b) in FIG. 7. A direction perpendicular to the horizontal direction is a vertical direction.

In the foregoing embodiment, the first vector is constructed by using the two palm key points, and the direction of the first vector is used as the palm direction of the palm in the palm image, so that accuracy of acquiring the palm direction can be improved. Then, the starting point of the first vector is used as a new starting point to construct the second vector along the horizontal direction, and the direction of the second vector is used as the calibration direction, so that accuracy of acquiring the calibration direction can be improved. Then, the capturing angle of the palm in the palm image is determined based on the more accurate palm direction and calibration direction, so that accuracy of the capturing angle can be further improved, thereby improving accuracy of identity verification.

In an embodiment, the constructing a second vector along a horizontal direction by using the first palm key point or the second palm key point as a starting point includes: constructing, when it is recognized that the palm in the palm image is a left palm, the second vector along a first horizontal direction by using the first palm key point or the second palm key point as the starting point; and constructing, when it is recognized that the palm in the palm image is a right palm, the second vector along a second horizontal direction by using the first palm key point or the second palm key point as the starting point; the first horizontal direction and the second horizontal direction being opposite horizontal directions.

The foregoing horizontal directions include the first horizontal direction and the second horizontal direction, and the first horizontal direction is opposite to the second horizontal direction. The left palm image is a palm image captured by the image capturing unit for a left hand of the user. The right palm image is a palm image captured by the image capturing unit for a right hand of the user.

In an embodiment, when the palm image is a left palm image, the terminal may construct the second vector along the first horizontal direction by using the first palm key point as a new starting point. When the palm image is a right palm image, the second vector is constructed along the second horizontal direction by using the first palm key point as a new starting point.

In an embodiment, the terminal may use the first palm key point as the starting point of the first vector. When the palm image is a left palm image captured for a left hand of the user, the terminal may construct the second vector along the first horizontal direction by using the first palm key point (that is, the starting point of the first vector) as a new starting point. When the palm image is a right palm image captured for a right hand of the user, the second vector is constructed along the second horizontal direction by using the first palm key point (that is, the starting point of the first vector) as a new starting point. The first vector and the second vector have a common starting point, that is, starting points of the first vector and the second vector are both the first palm key point.

In the foregoing embodiment, when the palm image is captured for the left hand of the user, constructing the second vector along the first horizontal direction by using the first palm key point as a new starting point can improve construction accuracy of the second vector when the palm image is captured for the left hand of the user. When the palm image is captured for the right hand of the user, constructing the second vector along the second horizontal direction by using the first palm key point as a new starting point can improve construction accuracy of the second vector when the palm image is captured for the right hand of the user. In this way, the calibration direction is determined based on the more accurate second vector, so that accuracy of the calibration direction can be improved.

In an embodiment, the constructing, when it is recognized that the palm in the palm image is a left palm, the second vector along a first horizontal direction by using the first palm key point or the second palm key point as a starting point includes: constructing, when it is recognized that the palm in the palm image is a left palm, the second vector along a positive direction of a horizontal axis of an image coordinate system of the palm image by using the first palm key point as the starting point. The constructing, when it is recognized that the palm in the palm image is a right palm, the second vector along a second horizontal direction by using the first palm key point or the second palm key point as a starting point includes: constructing, when it is recognized that the palm in the palm image is a right palm, the second vector along a negative direction of the horizontal axis of the image coordinate system of the palm image by using the first palm key point as the starting point.

The image coordinate system is a coordinate system established based on the palm image. The first horizontal direction includes the positive direction of the horizontal axis of the image coordinate system, and the second horizontal direction includes the negative direction of the horizontal axis of the image coordinate system.

In some aspects, when the palm image is a left palm image captured for a left hand of the user, the terminal may construct the second vector along a positive direction of a horizontal axis of an image coordinate system of the left palm image by using the first palm key point (that is, the starting point of the first vector) as a new starting point. When the palm image is a right palm image captured for a right hand of the user, the terminal may construct the second vector along a negative direction of a horizontal axis of an image coordinate system of the right palm image by using the first palm key point (that is, the starting point of the first vector) as a new starting point.

In the foregoing embodiment, when the palm image is a left palm image, constructing the second vector along a positive direction of a horizontal axis of an image coordinate system of the left palm image by using the first palm key point as a new starting point can improve construction accuracy of the second vector for the left palm image. When the palm image is a right palm image, constructing the second vector along a negative direction of a horizontal axis of an image coordinate system of the right palm image by using the first palm key point as a new starting point can improve construction accuracy of the second vector for the right palm image.

In an embodiment, the first palm key point is a finger gap point located between a ring finger and a little finger of the palm in the palm image; and the second palm key point is a finger gap point located between an index finger and a middle finger of the palm in the palm image.

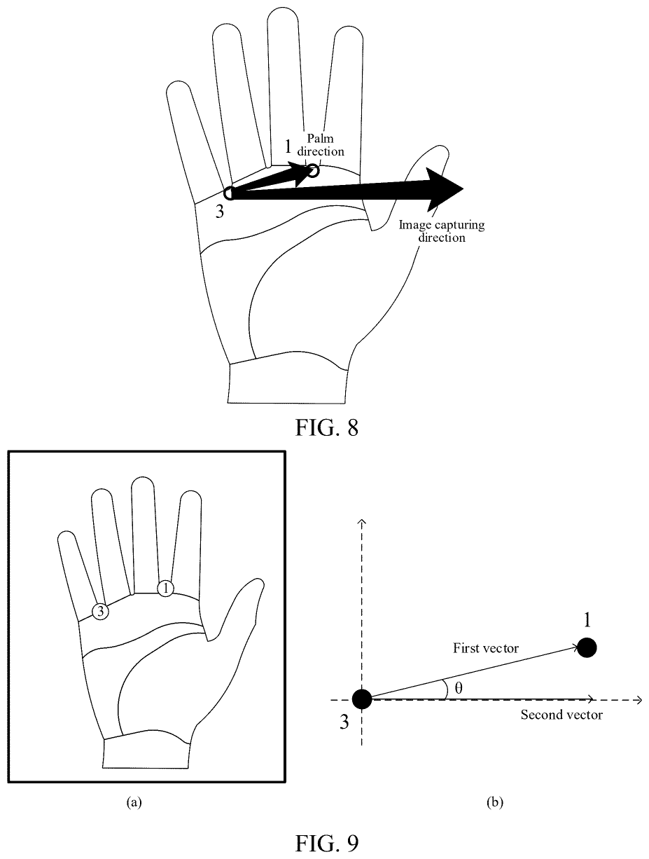

In an embodiment, as shown in FIG. 8, when the palm image is a left palm image captured for a left hand of the user (after mirroring in the capturing process, the left palm image is shown in FIG. 8), the terminal may construct the first vector by using the first palm key point (that is, a key point 3 in FIG. 8) as the starting point of the first vector and by using the second palm key point (that is, a key point 1 in FIG. 8) as the end point of the first vector. The terminal may use the direction of the first vector as a direction of the palm in the palm image to obtain the palm direction. Then, the terminal may construct a second vector along a positive direction of a horizontal axis of an image coordinate system of the left palm image by using the key point 3 as a new starting point. A direction of the second vector is the positive direction of the horizontal axis, that is, a calibration direction.

In an embodiment, when the user uses a left hand for positive palm verification, as shown in FIG. 9, when the palm image is a left palm image captured for the left hand of the user (after mirroring in the capturing process, the left palm image is shown in part (a) in FIG. 9), referring to part (b) in FIG. 9, the terminal may determine a capturing angle of a palm in the left palm image according to a difference between a palm direction (that is, the direction of the first vector) and a calibration direction (that is, the direction of the second vector) for the left palm image.

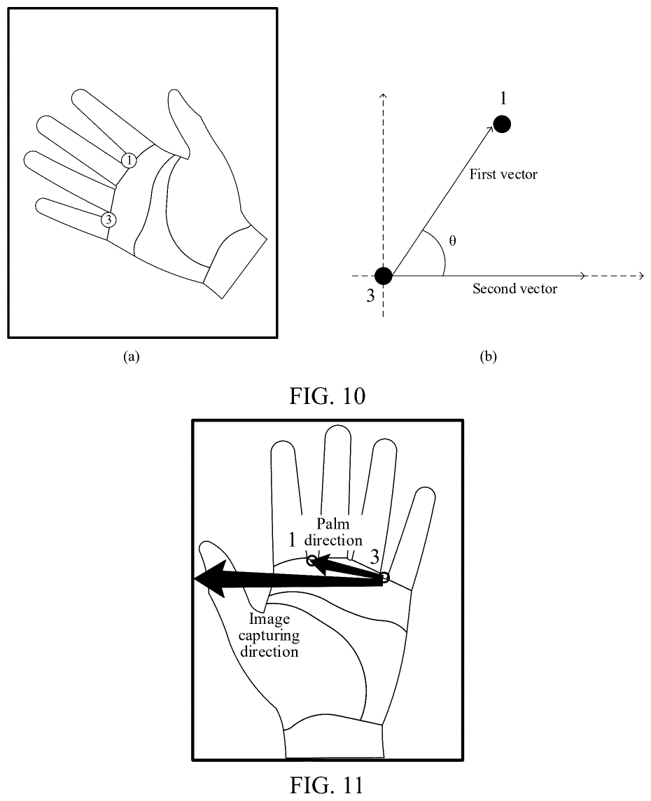

In an embodiment, when the user uses a left hand for non-positive palm verification, as shown in FIG. 10, when the palm image is a left palm image captured for the left hand of the user (after mirroring in the capturing process, the left palm image is shown in part (a) in FIG. 10), referring to part (b) in FIG. 10, the terminal may determine a capturing angle of a palm in the left palm image according to a difference between a palm direction (that is, the direction of the first vector) and a calibration direction (that is, the direction of the second vector) for the left palm image. A capturing angle obtained through calculation when the user uses a right hand for positive palm verification is less than a capturing angle obtained through calculation when the user uses the right hand for non-positive palm verification.

In an embodiment, as shown in FIG. 11, when the palm image is a right palm image captured for a right hand of the user (after mirroring in the capturing process, the right palm image is shown in FIG. 11), the terminal may construct the first vector by using the first palm key point (that is, a key point 3 in FIG. 11) as the starting point of the first vector and by using the second palm key point (that is, a key point 1 in FIG. 11) as the end point of the first vector. The terminal may use the direction of the first vector as a direction of the palm in the palm image to obtain the palm direction. Then, the terminal may construct a second vector along a positive direction of a horizontal axis of an image coordinate system of the right palm image by using the key point 3 as a new starting point. A direction of the second vector is a negative direction of the horizontal axis, that is, a calibration direction.

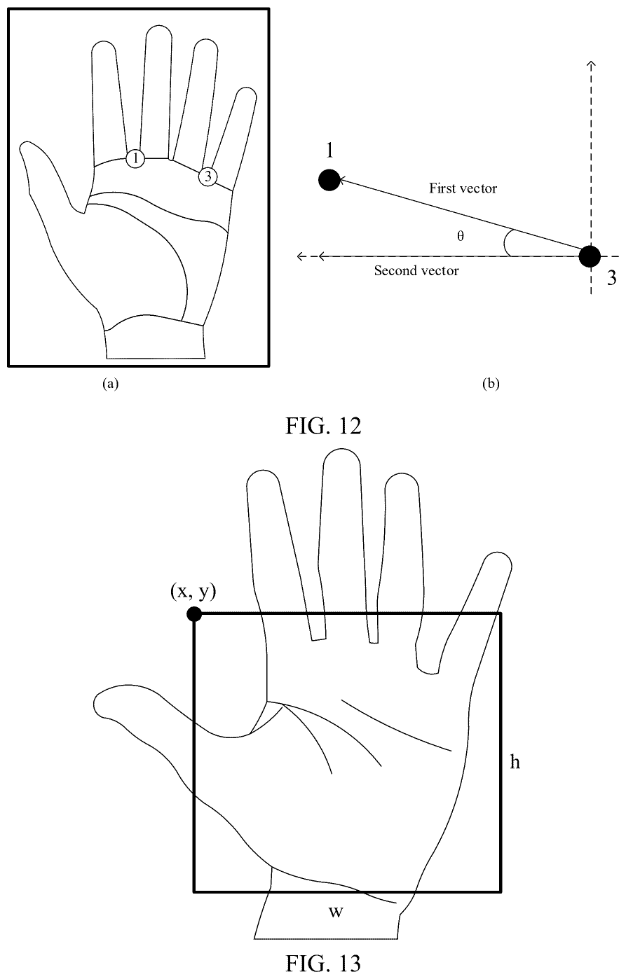

In an embodiment, when the user uses a right hand for positive palm verification, as shown in FIG. 12, when the palm image is a right palm image captured for the right hand of the user (after mirroring in the capturing process, the right palm image is shown in part (a) in FIG. 12), referring to part (b) in FIG. 12, the terminal may determine a capturing angle of a palm in the right palm image according to a difference between a palm direction (that is, the direction of the first vector) and a calibration direction (that is, the direction of the second vector) for the right palm image.

In an embodiment, when the user uses a right hand for non-positive palm verification, when the palm image is a right palm image captured for the right hand of the user, the terminal may determine a capturing angle of a palm in the right palm image according to a difference between a palm direction (that is, the direction of the first vector) and a calibration direction (that is, the direction of the second vector) for the right palm image. A capturing angle obtained through calculation when the user uses the right hand for positive palm verification is less than a capturing angle obtained through calculation when the user uses the right hand for non-positive palm verification.

In the foregoing embodiment, the finger gap point between the ring finger and the little finger of the palm in the palm image is used as the first palm key point, and the finger gap point between the index finger and the middle finger of the palm in the palm image is used as the second palm key point. Therefore, the relatively distant positions of the first palm key point and the second palm key point in the palm can avoid a case in which the key points overlap. In this way, constructing the first vector based on the first palm key point and the second palm key point can improve construction accuracy of the first vector.

In an embodiment, the acquiring, in response to an identity verification trigger event, at least one palm image captured with a preset capturing field of view includes: acquiring, in response to the identity verification trigger event, at least one initial image captured with the preset capturing field of view; extracting, for each initial image, an image feature of the initial image, and performing palm detection based on the image feature of the initial image to obtain a palm region box corresponding to the initial image; and cropping the initial image based on the palm region box to obtain a palm image corresponding to the initial image.

In some aspects, the terminal may acquire at least one initial image captured by the image capturing unit. The initial image may include a palm or may not include a palm. For each initial image, the terminal may perform feature extraction on the initial image to obtain an image feature of the initial image, and perform palm detection based on the image feature of the initial image to obtain a palm region box corresponding to the initial image. The palm region box obtained through detection is used for positioning a region in which a palm is located in the initial image. Then, the terminal may crop the initial image based on the palm region box to obtain a palm image that corresponds to the initial image and includes a palm. If a palm exists in the initial image, the terminal may detect a palm region box used for positioning a region in which the palm is located in the initial image, and crop the initial image based on the palm region box to obtain a palm image including the palm. If no palm exists in the initial image, the terminal cannot detect a palm region box from the initial image.

In an embodiment, the terminal may input each initial image to a trained palm detection model. For each initial image, the terminal may perform feature extraction on the initial image by using the trained palm detection model to obtain an image feature of the initial image, and perform palm detection based on the image feature of the initial image to obtain a palm region box corresponding to the initial image.

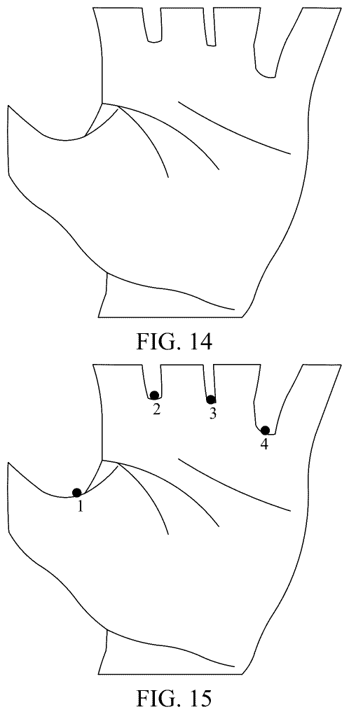

In an embodiment, as shown in FIG. 13, region box information of the palm region box detected from the initial image includes position information of the palm region box, that is, coordinates (x, y) of the palm region box in the initial image. The region box information of the palm region box further includes a width w and a height h of the palm region box. Then, as shown in FIG. 14, the terminal may crop the initial image based on the palm region box to obtain the palm image that corresponds to the initial image and includes the palm.

In the foregoing embodiment, at least one initial image captured by the image capturing unit is acquired. For each initial image, a palm region box corresponding to the initial image is detected, and the initial image is cropped based on the palm region box, to obtain a palm image corresponding to the initial image. Then, key point detection is performed based on the palm image obtained through cropping, so that accuracy of key point detection can be improved.

In an embodiment, the palm region box is obtained through prediction by using a trained palm detection model. The method further includes: acquiring a sample image, the sample image including a sample palm, and the sample image carrying a reference palm region box calibrated for the sample palm; performing palm detection on the sample image by using a to-be-trained palm detection model to obtain a predicted palm region box; determining a target loss value according to a position difference and a width and height difference between the predicted palm region box and the reference palm region box; and training the to-be-trained palm detection model by using the target loss value to obtain the trained palm detection model.

The reference palm region box is a palm region box used as a reference in a process of training the to-be-trained palm detection model. The predicted palm region box is a palm region box obtained by performing palm detection on the sample image by using the to-be-trained palm detection model in the training process. The position difference is a difference between a position of the predicted palm region box in the sample image and a position of the reference palm region box in the sample image. The position difference includes a difference between a horizontal coordinate of the predicted palm region box in the sample image and a horizontal coordinate of the reference palm region box in the sample image, and a difference between a vertical coordinate of the predicted palm region box in the sample image and a vertical coordinate of the reference palm region box in the sample image. The width and height difference includes a width difference and a height difference. The width difference is a difference between a width of the predicted palm region box and a width of the reference palm region box. The height difference is a difference between a height of the predicted palm region box and a height of the reference palm region box. In this embodiment, for the target loss value, not only the position difference between the predicted palm region box and the reference palm region box is considered, but also the width and height difference between the predicted palm region box and the reference palm region box is considered.

In some aspects, the terminal may acquire a sample image including a sample palm, the sample image carrying a reference palm region box calibrated in advance for the sample palm. The terminal may input the sample image to a to-be-trained palm detection model to perform palm detection on the sample image by using the to-be-trained palm detection model, and output a predicted palm region box corresponding to the sample image. The predicted palm region box is used for positioning a region in which the sample palm is located in the sample image. The terminal may determine a target loss value according to a position difference and a width and height difference between the predicted palm region box and the reference palm region box, and perform iterative training on the to-be-trained palm detection model in a direction for reducing the target loss value, until an iteration stop condition is satisfied, to obtain a trained palm detection model.

In an embodiment, the iteration stop condition may be at least one of that the number of iterations reaches a preset number of iterations or that the target loss value is less than a preset loss value.

In an embodiment, the terminal may acquire an initial sample image including at least one sample palm. For each sample palm in the initial sample image, a reference palm region box is calibrated for the sample palm to obtain the sample image.

In an embodiment, the terminal may perform weighted processing on the position difference and the width and height difference between the predicted palm region box and the reference palm region box, and directly use a weighted result as the target loss value.

In the foregoing embodiment, palm detection is performed on a sample image by using a to-be-trained palm detection model to obtain a predicted palm region box, a target loss value is determined according to a position difference and a width and height difference between the predicted palm region box and a reference palm region box in the sample image, and then the to-be-trained palm detection model is trained by using the target loss value to obtain a trained palm detection model. In this way, accuracy of key point detection of the trained palm detection model can be improved.

In an embodiment, the acquiring a sample image includes: acquiring an initial sample image, and dividing the initial sample image into a plurality of image blocks; and calibrating at least one reference palm region box for each image block in the initial sample image to obtain the sample image.

In some aspects, the terminal may acquire at least one initial sample image. For each initial sample image, the terminal may perform image division on the initial sample image to obtain a plurality of image blocks corresponding to the initial sample image. Then, the terminal may calibrate at least one reference palm region box for each of the image blocks in the initial sample image to obtain a sample image corresponding to the initial sample image.

In the foregoing embodiment, the initial sample image is divided into a plurality of image blocks, and at least one reference palm region box is calibrated for each of the image blocks in the initial sample image to obtain the sample image. Because a plurality of reference palm region boxes are correspondingly calibrated for the sample image, information for reference may be added while the number of sample images is not changed. Therefore, training the to-be-trained palm detection model by using the sample image to obtain the trained palm detection model can improve accuracy of key point detection of the trained palm detection model.

In an embodiment, the sample image further carries a reference confidence of the reference palm region box; and the determining a target loss value according to a position difference and a width and height difference between the predicted palm region box and the reference palm region box includes: determining a first loss value according to the position difference and the width and height difference between the predicted palm region box and the reference palm region box; determining a predicted confidence of the predicted palm region box according to a region overlap between the predicted palm region box and the reference palm region box, the region overlap and the predicted confidence being positively correlated; determining a second loss value according to a confidence difference between the predicted confidence and the reference confidence; and determining the target loss value based on the first loss value and the second loss value.

The region overlap is an overlapping degree between a region corresponding to the predicted palm region box and a region corresponding to the reference palm region box. The region overlap and the predicted confidence being positively correlated means that a higher region overlap indicates a higher predicted confidence, and a lower region overlap indicates a lower predicted confidence. The reference confidence is a confidence of the reference palm region box used as a reference in a process of training the to-be-trained palm detection model. The predicted confidence is a confidence of a predicted palm region box obtained by performing palm detection on a sample image by using the to-be-trained palm detection model in the training process. The first loss value is a loss value determined based on the position difference and the width and height difference between the predicted palm region box and the reference palm region box. The second loss value is a loss value determined based on the confidence difference between the predicted confidence and the reference confidence. In this embodiment, both the first loss value and the second loss value are considered in the target loss value.

In an embodiment, when a sample palm exists in the predicted palm region box, the terminal may determine a predicted confidence of the predicted palm region box according to a region overlap between the predicted palm region box and the reference palm region box. When no sample palm exists in the predicted palm region box, the predicted confidence of the predicted palm region box is determined as zero.

In an embodiment, the region overlap may include a region intersection-over-union between a region corresponding to the predicted palm region box and a region corresponding to the reference palm region box. The region intersection-over-union is a ratio of a region intersection to a region union. The region intersection is an intersection between the region corresponding to the predicted palm region box and the region corresponding to the reference palm region box. The region union is a union between the region corresponding to the predicted palm region box and the region corresponding to the reference palm region box. The terminal may determine the predicted confidence of the predicted palm region box according to the region intersection-over-union between the predicted palm region box and the reference palm region box. The region intersection-over-union and the predicted confidence are positively correlated.

In an embodiment, the terminal may perform weighted processing based on the first loss value and the second loss value, and directly use a weighted result as the target loss value.

In the foregoing embodiment, the first loss value is determined by using the position difference and the width and height difference between the predicted palm region box and the reference palm region box, the second loss value is determined according to the confidence difference between the predicted confidence and the reference confidence, and then, a richer target loss value is determined according to the first loss value and the second loss value. Then, the to-be-trained palm detection model is trained by using the target loss value to obtain a trained palm detection model, so that accuracy of key point detection of the trained palm detection model can be further improved.

In an embodiment, the determining the target loss value based on the first loss value and the second loss value includes: performing category probability prediction on an object in the predicted palm region box by using the to-be-trained palm detection model to obtain a palm category probability that the object in the predicted palm region box belongs to a palm; determining a third loss value according to a difference between the predicted palm category probability and a palm category probability of the sample palm in the reference palm region box; and determining the target loss value based on the first loss value, the second loss value, and the third loss value.

The third loss value is a loss value determined based on a difference between the predicted palm category probability and the palm category probability of the sample palm in the reference palm region box. The first loss value, the second loss value, and the third loss value are all considered in the target loss value in this embodiment.

In some aspects, the object in the predicted palm region box may be a palm, or may not be a palm. The terminal may perform category probability prediction on the object in the predicted palm region box by using a to-be-trained palm detection model, to obtain a palm category probability that the object in the predicted palm region box belongs to a palm. Then, the terminal may determine a third loss value according to a difference between the predicted palm category probability and the palm category probability of the sample palm in the reference palm region box, and determine the target loss value according to the first loss value, the second loss value, and the third loss value.

In an embodiment, the terminal may perform weighted processing on the first loss value, the second loss value, and the third loss value, and directly use a weighted result as the target loss value.

In an embodiment, the target loss value may be obtained through calculation by using the following loss function:

$$L = λ 1 {\sum }_{i = 0}^{{s}^{2}} {\sum }_{j = 0}^{B} {\prod }_{ij}^{obj} [ {( {x}_{i} - {\tilde{x}}_{i} )}^{2} + {( {y}_{i} - {\tilde{y}}_{i} )}^{2} ] + λ 2 {\sum }_{i = 0}^{{s}^{2}} {\sum }_{j = 0}^{B} {\prod }_{ij}^{obj} [ {( \sqrt{{w}_{i}} - \sqrt{{\tilde{w}}_{i}} )}^{2} + {( \sqrt{{h}_{i}} - \sqrt{{h}_{i} ∼} )}^{2} ] + {\sum }_{i = 0}^{{s}^{2}} {\sum }_{j = 0}^{B} {\prod }_{ij}^{obj} {( {C}_{i} - {\tilde{C}}_{i} )}^{2} + λ 3 {\sum }_{i = 0}^{{s}^{2}} {\sum }_{j = 0}^{B} {\prod }_{ij}^{noobj} {( {C}_{i} - {\tilde{C}}_{i} )}^{2} + {\sum }_{i = 0}^{{s}^{2}} {\prod }_{i}^{obj} {\sum }_{c ∈ classes} {( {p}_{i} ( c ) - \tilde{{p}_{i} ( c )} )}^{2}$$

where L is the target loss value, s² is the number of image blocks in the sample image, and B is the number of reference palm region boxes calibrated for each image block. ij represents a j^{th} reference palm region box of an i^{th} image block. obj represents that a sample palm exists in the reference palm region box, and noobj represents that no sample palm exists in the reference palm region box. xᵢ represents a horizontal coordinate of the reference palm region box located in the sample image. yᵢ represents a vertical coordinate of the reference palm region box located in the sample image. \tilde{x}ᵢ represents a horizontal coordinate of the predicted palm region box located in the sample image, and y; represents a vertical coordinate of the predicted palm region box located in the sample image. (xᵢ−\tilde{x}ᵢ) represents a difference between the horizontal coordinate of the predicted palm region box located in the sample image and the horizontal coordinate of the reference palm region box located in the sample image. (yᵢ−\tilde{y}ᵢ) represents a difference between the vertical coordinate of the predicted palm region box located in the sample image and the vertical coordinate of the reference palm region box located in the sample image. (xᵢ−\tilde{x}ᵢ)²+(yᵢ−\tilde{y}ᵢ)² represents a difference between a position of the predicted palm region box located in the sample image and a position of the reference palm region box located in the sample image. wᵢ represents a width of the reference palm region box. hᵢ represents a height of the reference palm region box. \tilde{w}ᵢ represents a width of the predicted palm region box. \tilde{h}ᵢ represents a height of the predicted palm region box. (\sqrt{wᵢ}−\sqrt{\tilde{w}ᵢ}) represents a width difference between the width of the predicted palm region box and the width of the reference palm region box. (\sqrt{hᵢ}−\sqrt{\tilde{h}ᵢ}) represents a height difference between the height of the predicted palm region box and the height of the reference palm region box. Cᵢ represents a reference confidence of the reference palm region box. \tilde{C}ᵢ represents a predicted confidence of the predicted palm region box. (Cᵢ−\tilde{C}ᵢ) represents a confidence difference between the predicted confidence and the reference confidence. c∈classes represents a category to which an object in the palm region box belongs. In this disclosure, the category to which the object belongs includes a palm category. If c is a palm category, pᵢ(c) represents the palm category probability of the sample palm in the reference palm region box, and pᵢ{tilde over (()}c) represents a palm category probability that an object in the predicted palm region box belongs to a palm. (pᵢ(c)−pᵢ{tilde over (()}c)) represents a difference between the palm category probability and the palm category probability of the sample palm in the reference palm region box. λ1, λ2, and λ3 are preset constants.

In the foregoing embodiment, the third loss value is determined according to a difference between the predicted palm category probability and the palm category probability of the sample palm in the reference palm region box, and a richer target loss value is determined according to the first loss value, the second loss value, and the third loss value. Then, the to-be-trained palm detection model is trained by using the target loss value to obtain a trained palm detection model, so that accuracy of key point detection of the trained palm detection model can be further improved.

In an embodiment, the detecting key points in each palm image to obtain respective palm key points of the each palm image includes: performing, for the each palm image, feature extraction on the palm image to obtain an image feature of the palm image; and performing key point detection according to the image feature of the palm image to obtain the palm key points corresponding to the palm image.

In some aspects, for each palm image, the terminal may perform convolution processing on the palm image to extract the image feature of the palm image from the palm image. Then, the terminal may perform key point detection according to the image feature of the palm image to obtain the palm key points corresponding to the palm image.

In an embodiment, for each palm image, the terminal may input the palm image to a trained palm key point detection model, to perform feature extraction on the palm image by using the palm key point detection model, to obtain an image feature of the palm image. Then, the terminal may perform key point detection according to the image feature of the palm image to obtain the palm key points corresponding to the palm image.

In an embodiment, there may be at least two palm key points obtained through detection. As shown in FIG. 15, after acquiring a palm image obtained through cropping for an initial image, the terminal may perform key point detection on the palm image obtained through cropping, to obtain palm key points of a palm in the palm image obtained through cropping, that is, a palm key point 1, a palm key point 2, a palm key point 3, and a palm key point 4.

In the foregoing embodiment, the image feature of the palm image is extracted. Because the image feature of the palm image may be used for representing rich feature information of a palm in the palm image, key point detection is performed according to the image feature of the palm image, to obtain palm key points corresponding to the palm image. In this way, accuracy of key point detection can be improved.

In an embodiment, the performing key point detection according to the image feature of the palm image to obtain the palm key points corresponding to the palm image includes: performing key point detection according to the image feature of the palm image to obtain initial key points corresponding to the palm image; cropping, for each of the initial key points, the palm image with reference to the initial key point to obtain a cropped image that covers the initial key point and that conforms to a preset size; performing feature extraction on the cropped image to obtain an image feature of the cropped image, and performing key point detection according to the image feature of the cropped image to obtain palm key points corresponding to the cropped image.

The initial key point is a palm key point obtained by performing preliminary key point detection on the palm image. The initial key point may not be very accurate. To acquire more accurate palm key points, the palm image may be cropped with reference to the initial key point, to obtain a cropped image that covers the initial key point and that conforms to a preset size, and advanced key point detection is performed based on the cropped image, to obtain palm key points that are more accurate than the initial key point.

In some aspects, the terminal may perform initial key point detection according to the image feature of the palm image to obtain initial key points corresponding to the palm image. For each of the initial key points, the terminal may crop the palm image according to a preset size with reference to the initial key point, to obtain a cropped image that covers the initial key point and that conforms to the preset size. A size of the cropped image is smaller than or equal to a size of the palm image. Then, the terminal may perform feature extraction on the cropped image to obtain an image feature of the cropped image, and perform advanced key point detection according to the image feature of the cropped image to obtain palm key points corresponding to the cropped image.

In an embodiment, for each palm image, the terminal may input the palm image to a trained palm key point detection model, to perform feature extraction on the palm image by using the palm key point detection model, to obtain an image feature of the palm image, and perform initial key point detection according to the image feature of the palm image to obtain initial key points corresponding to the palm image. For each of the initial key points, the terminal may crop the palm image according to a preset size with reference to the initial key point, to obtain a cropped image that covers the initial key point and that conforms to the preset size. Then, the terminal may perform feature extraction on the cropped image to obtain an image feature of the cropped image, and then input the palm image to the trained palm key point detection model, to perform advanced key point detection on the image feature of the cropped image by using the palm key point detection model, to output palm key points corresponding to the cropped image.

In the foregoing embodiment, initial key point detection is performed by using the image feature of the palm image to obtain initial key points corresponding to the palm image, and the initial key points obtained through initial detection may not be very accurate. Therefore, for each of the initial key points, the palm image is cropped with reference to the initial key point, to obtain a cropped image that covers the initial key point and that conforms to a preset size. Then, an image feature of the cropped image is extracted, and advanced key point detection is performed according to the image feature of the cropped image, to obtain palm key points corresponding to the cropped image. In this way, accuracy of key point detection can be further improved.

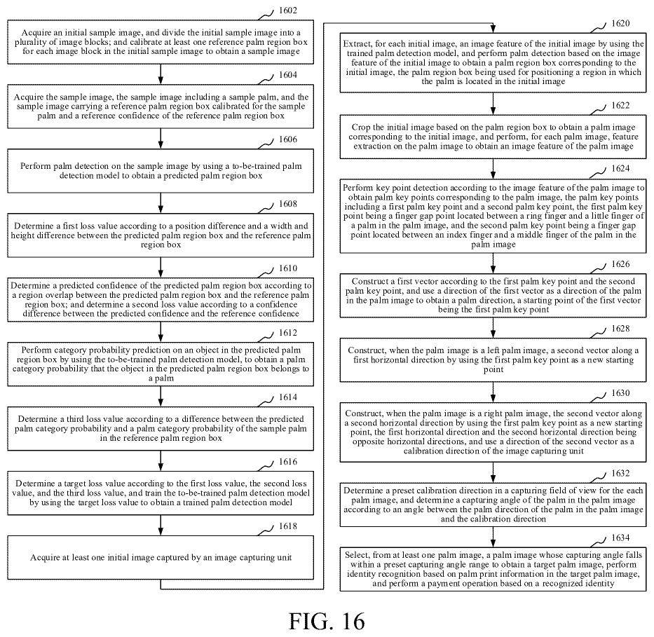

As shown in FIG. 16, in an embodiment, an identity verification method is provided. In this embodiment, description is provided by using an example in which the method is applied to the terminal 102 in FIG. 1. The method, in some examples, includes the following operations.
Operation 1602: Acquire an initial sample image, and divide the initial sample image into a plurality of image blocks; and calibrate at least one reference palm region box for each image block in the initial sample image to obtain a sample image.
Operation 1604: Acquire the sample image, the sample image including a sample palm, and the sample image carrying a reference palm region box calibrated for the sample palm and a reference confidence of the reference palm region box.
Operation 1606: Perform palm detection on the sample image by using a to-be-trained palm detection model to obtain a predicted palm region box.
Operation 1608: Determine a first loss value according to a position difference and a width and height difference between the predicted palm region box and the reference palm region box.
Operation 1610: Determine a predicted confidence of the predicted palm region box according to a region overlap between the predicted palm region box and the reference palm region box; and determine a second loss value according to a confidence difference between the predicted confidence and the reference confidence.
Operation 1612: Perform category probability prediction on an object in the predicted palm region box by using the to-be-trained palm detection model, to obtain a palm category probability that the object in the predicted palm region box belongs to a palm.
Operation 1614: Determine a third loss value according to a difference between the predicted palm category probability and a palm category probability of the sample palm in the reference palm region box.
Operation 1616: Determine a target loss value according to the first loss value, the second loss value, and the third loss value, and train the to-be-trained palm detection model by using the target loss value to obtain a trained palm detection model.
Operation 1618: Acquire at least one initial image captured by an image capturing unit.
Operation 1620: Extract, for each initial image, an image feature of the initial image by using the trained palm detection model, and perform palm detection based on the image feature of the initial image to obtain a palm region box corresponding to the initial image, the palm region box being used for positioning a region in which the palm is located in the initial image.
Operation 1622: Crop the initial image based on the palm region box to obtain a palm image corresponding to the initial image, and perform, for each palm image, feature extraction on the palm image to obtain an image feature of the palm image.
Operation 1624: Perform key point detection according to the image feature of the palm image to obtain palm key points corresponding to the palm image, the palm key points including a first palm key point and a second palm key point, the first palm key point being a finger gap point located between a ring finger and a little finger of a palm in the palm image, and the second palm key point being a finger gap point located between an index finger and a middle finger of the palm in the palm image.
Operation 1626: Construct a first vector according to the first palm key point and the second palm key point, and use a direction of the first vector as a direction of the palm in the palm image to obtain a palm direction, a starting point of the first vector being the first palm key point.
Operation 1628: Construct, when the palm image is a left palm image, a second vector along a first horizontal direction by using the first palm key point as a new starting point.
Operation 1630: Construct, when the palm image is a right palm image, the second vector along a second horizontal direction by using the first palm key point as a new starting point, the first horizontal direction and the second horizontal direction being opposite horizontal directions, and use a direction of the second vector as a calibration direction of the image capturing unit.
Operation 1632: Determine a preset calibration direction in a capturing field of view for the each palm image, and determine a capturing angle of the palm in the palm image according to an angle between the palm direction of the palm in the palm image and the calibration direction.
Operation 1634: Select, from at least one palm image, a palm image whose capturing angle falls within a preset capturing angle range to obtain a target palm image, perform identity recognition based on palm print information in the target palm image, and perform a payment operation based on a recognized identity.

This disclosure further provides an application scenario. The foregoing identity verification method is applied to the application scenario. In some aspects, the identity verification method may be applied to a scenario of palm verification payment in supermarket shopping. When a customer shops in a supermarket, the customer needs to go to a cashier to pay after selecting commodities. The customer may choose to pay through palm verification payment on a palm verification device. A trained palm detection model is deployed in the palm verification device, and operations of training the palm detection model may include: acquiring an initial sample image, and dividing the initial sample image into a plurality of image blocks; calibrating at least one reference palm region box for each image block in the initial sample image to obtain a sample image; acquiring the sample image, the sample image including a sample palm, and the sample image carrying a reference palm region box calibrated for the sample palm and a reference confidence of the reference palm region box; performing palm detection on the sample image by using a to-be-trained palm detection model to obtain a predicted palm region box; determining a first loss value according to a position difference and a width and height difference between the predicted palm region box and the reference palm region box; determining a predicted confidence of the predicted palm region box according to a region overlap between the predicted palm region box and the reference palm region box; determining a second loss value according to a confidence difference between the predicted confidence and the reference confidence; performing category probability prediction on an object in the predicted palm region box by using the to-be-trained palm detection model to obtain a palm category probability that the object in the predicted palm region box belongs to a palm; determining a third loss value according to a difference between the predicted palm category probability and a palm category probability of the sample palm in the reference palm region box; and determining a target loss value according to the first loss value, the second loss value, and the third loss value, and training the to-be-trained palm detection model by using the target loss value to obtain a trained palm detection model.

When the customer places a palm above the palm verification device, the palm verification device may acquire at least one initial image captured by an image capturing unit. The initial image may include the palm of the customer or may not include the palm of the customer. For each initial image, an image feature of the initial image is extracted by using the trained palm detection model, and palm detection is performed based on the image feature of the initial image to obtain a palm region box corresponding to the initial image. The palm region box is used for positioning a region in which a palm is located in the initial image. The initial image is cropped based on the palm region box to obtain a palm image corresponding to the initial image. For each palm image, feature extraction is performed on the palm image to obtain an image feature of the palm image. Key point detection is performed according to the image feature of the palm image to obtain palm key points corresponding to the palm image. The palm key points include a first palm key point and a second palm key point. The first palm key point is a finger gap point located between a ring finger and a little finger of a palm in the palm image. The second palm key point is a finger gap point located between an index finger and a middle finger of the palm in the palm image.

The palm verification device may construct a first vector according to the first palm key point and the second palm key point, and use a direction of the first vector as a direction of the palm in the palm image to obtain a palm direction, a starting point of the first vector being the first palm key point. When the palm image is a left palm image, a second vector is constructed along a first horizontal direction by using the first palm key point as a new starting point. When the palm image is a right palm image, the second vector is constructed along a second horizontal direction by using the first palm key point as a new starting point. The first horizontal direction and the second horizontal direction are opposite horizontal directions, and a direction of the second vector is used as a calibration direction of the image capturing unit. A preset calibration direction in a capturing field of view is determined for the each palm image, and a capturing angle of the palm in the palm image is determined according to an angle between the palm direction of the palm in the palm image and the calibration direction. A palm image whose capturing angle falls within a preset capturing angle range is selected from at least one palm image to obtain a target palm image of the customer, and palm verification payment processing is performed based on palm print information in the target palm image of the customer.

In this disclosure, palm key point detection is performed on a captured palm image, a capturing angle of a palm is automatically determined based on detected palm key points, and a target palm image of a customer for palm verification payment is selected from captured palm images based on the capturing angle, to avoid a case of accidental payment by a cashier at a software level when the cashier indicates a customer to perform palm verification, thereby reducing use costs of the palm verification device in a supermarket shopping scenario.

This disclosure further provides an application scenario. The foregoing identity verification method is applied to the application scenario. In some aspects, the identity verification method may be applied to a palm verification payment scenario in which friends split a dinner bill. A plurality of friends usually need to split a dinner bill after dining together. Through the identity verification method of this disclosure, palm verification payment can be implemented among the friends. In this way, in this disclosure, palm key point detection is performed on captured palm images, a capturing angle of a palm is automatically determined based on detected palm key points, and a target palm image of a friend used for palm verification payment is selected from the captured palm images based on the capturing angle, to avoid a case of accidental payment by a verification initiator at a software level when the verification initiator indicates the friend to perform palm verification, thereby reducing use costs of a palm verification device in a scenario of palm verification payment among friends.

Although the operations in the flowcharts of the foregoing embodiments are displayed in sequence, these operations are not necessarily performed in sequence. Unless otherwise explicitly specified in this disclosure, execution of the steps is not strictly limited, and the steps may be performed in other sequences. Moreover, at least some of the steps in each embodiment may include a plurality of sub-steps or a plurality of stages. The sub-steps or stages are not necessarily performed at the same moment but may be performed at different moments. Execution of the sub-steps or stages is not necessarily sequentially performed, but may be performed alternately with other steps or at least some of sub-steps or stages of other steps.

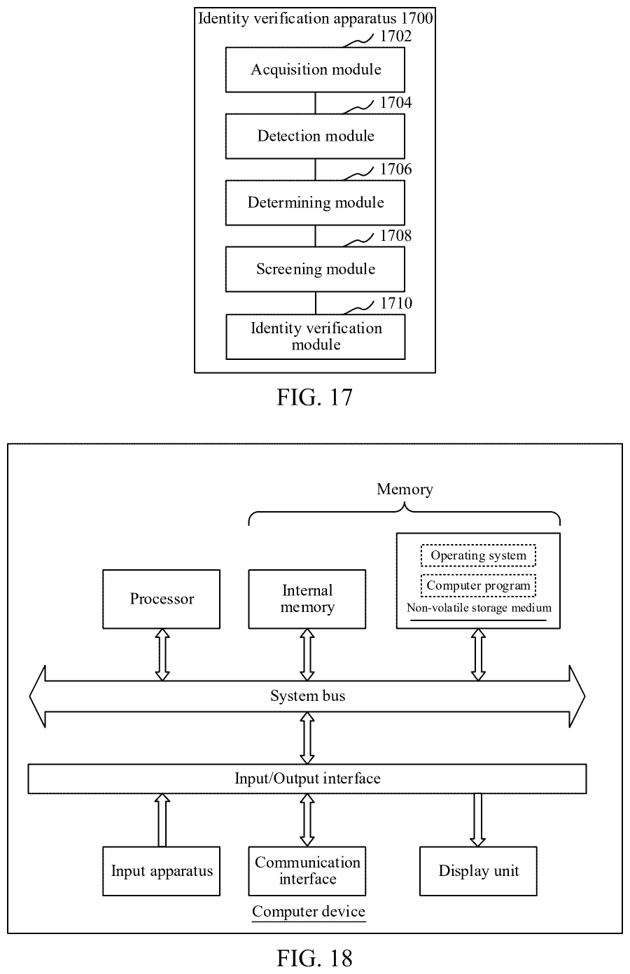

In an embodiment, as shown in FIG. 17, an identity verification apparatus 1700 is provided. The apparatus, in some examples, includes:
an acquisition module 1702, configured to acquire, in response to an identity verification trigger event, at least one palm image captured with a preset capturing field of view;
a detection module 1704, configured to detect key points in each palm image to obtain respective palm key points of the each palm image;
a determining module 1706, configured to determine a palm direction of a palm in the each palm image respectively according to the respective palm key points of the each palm image; and determine a preset calibration direction in the capturing field of view for the each palm image, and determine a capturing angle of the palm in the palm image according to an angle between the palm direction of the palm in the palm image and the calibration direction;
a screening module 1708, configured to select, from the at least one palm image, a palm image whose capturing angle is within a preset capturing angle range to obtain a target palm image; and
an identity verification module 1710, configured to perform identity verification according to the target palm image.

In an embodiment, the determining module 1706 is further configured to construct, for the each palm image if the palm key points of the palm image include a first palm key point and a second palm key point, a first vector according to the first palm key point and the second palm key point, and use a direction of the first vector as the palm direction of the palm in the palm image.

In an embodiment, the determining module 1706 is further configured to construct, for the each palm image if the palm key points of the palm image include a first palm key point and a second palm key point, a second vector along a horizontal direction by using the first palm key point or the second palm key point as a starting point, and use a direction of the second vector as the preset calibration direction in the capturing field of view.

In an embodiment, the determining module 1706 is further configured to construct, when it is recognized that the palm in the palm image is a left palm, the second vector along a first horizontal direction by using the first palm key point or the second palm key point as a starting point; and construct, when it is recognized that the palm in the palm image is a right palm, the second vector along a second horizontal direction by using the first palm key point or the second palm key point as a starting point; the first horizontal direction and the second horizontal direction being opposite horizontal directions.

In an embodiment, the determining module 1706 is further configured to construct, when it is recognized that the palm in the palm image is a left palm, the second vector along a positive direction of a horizontal axis of an image coordinate system of the palm image by using the first palm key point as the starting point; and construct, when it is recognized that the palm in the palm image is a right palm, the second vector along a negative direction of the horizontal axis of the image coordinate system of the palm image by using the first palm key point as the starting point.

In an embodiment, the first palm key point is a finger gap point located between a ring finger and a little finger of the palm in the palm image; and the second palm key point is a finger gap point located between an index finger and a middle finger of the palm in the palm image.

In an embodiment, the acquisition module 1702 is further configured to acquire, in response to the identity verification trigger event, at least one initial image captured with the preset capturing field of view; extract, for each initial image, an image feature of the initial image, and perform palm detection based on the image feature of the initial image to obtain a palm region box corresponding to the initial image; and crop the initial image based on the palm region box to obtain a palm image corresponding to the initial image.

In an embodiment, the palm region box is obtained through prediction by using a trained palm detection model. The apparatus 1700 further includes: a training module, configured to acquire a sample image, the sample image including a sample palm, and the sample image carrying a reference palm region box calibrated for the sample palm; perform palm detection on the sample image by using a to-be-trained palm detection model to obtain a predicted palm region box; determine a target loss value according to a position difference and a width and height difference between the predicted palm region box and the reference palm region box; and train the to-be-trained palm detection model by using the target loss value to obtain the trained palm detection model.

In an embodiment, the training module is further configured to acquire an initial sample image, and divide the initial sample image into a plurality of image blocks; and calibrate at least one reference palm region box for each image block in the initial sample image to obtain the sample image.

In an embodiment, the sample image further carries a reference confidence of the reference palm region box; and the training module is further configured to determine a first loss value according to the position difference and the width and height difference between the predicted palm region box and the reference palm region box; determine a predicted confidence of the predicted palm region box according to a region overlap between the predicted palm region box and the reference palm region box, the region overlap and the predicted confidence being positively correlated; determine a second loss value according to a confidence difference between the predicted confidence and the reference confidence; and determine the target loss value based on the first loss value and the second loss value.

In an embodiment, the training module is further configured to perform category probability prediction on an object in the predicted palm region box by using the to-be-trained palm detection model to obtain a palm category probability that the object in the predicted palm region box belongs to a palm; determine a third loss value according to a difference between the predicted palm category probability and a palm category probability of the sample palm in the reference palm region box; and determine the target loss value based on the first loss value, the second loss value, and the third loss value.

In an embodiment, the detection module 1704 is further configured to perform, for the each palm image, feature extraction on the palm image to obtain an image feature of the palm image; and perform key point detection according to the image feature of the palm image to obtain the palm key points corresponding to the palm image.

In an embodiment, the detection module 1704 is further configured to perform key point detection according to the image feature of the palm image to obtain initial key points corresponding to the palm image; crop, for each of the initial key points, the palm image with reference to the initial key point to obtain a cropped image that covers the initial key point and that conforms to a preset size; perform feature extraction on the cropped image to obtain an image feature of the cropped image, and perform key point detection according to the image feature of the cropped image to obtain palm key points corresponding to the cropped image.

In an embodiment, the identity verification module 1710 is further configured to perform a payment operation in response to successful identity verification performed according to biological information in the target palm image.

According to the foregoing identity verification apparatus, at least one palm image captured with a preset capturing field of view is acquired in response to an identity verification trigger event, and key points are detected in each palm image to obtain respective palm key points of the each palm image. A palm direction of a palm in the each palm image is determined respectively according to the respective palm key points of the each palm image, a preset calibration direction in the capturing field of view is determined for the each palm image, and a capturing angle of the palm in the palm image is determined according to an angle between the palm direction of the palm in the palm image and the calibration direction. In this way, a palm image whose capturing angle falls within a preset capturing angle range for representing a party that is to perform payment is automatically selected from the at least one palm image, to obtain a target palm image, and identity verification is performed based on the target palm image. In a controllable way, verification can be correctly performed only when the palm is verified in a particular direction, thereby avoiding a case of incorrect determining.

All or some of the modules in the identity verification apparatus may be implemented through software, hardware, or combinations thereof. The modules may be built in or stand alone from a processor in a computer device in a form of hardware, or may be stored in a memory in a computer device in a form of software, so that the processor can invoke and execute operations corresponding to the modules.

In an embodiment, a computer device is provided. The computer device may be a terminal, and a diagram of an internal structure thereof may be shown in FIG. 18. The computer device includes a processor, a memory, an input/output (I/O) interface, a communication interface, a display unit, and an input apparatus. The processor, the memory, and the I/O interface are connected by using a system bus, and the communication interface, the display unit, and the input apparatus are connected to the system bus by using the I/O interface. The processor of the computer device is configured to provide computing and control capabilities. The memory of the computer device includes a non-volatile storage medium and an internal memory. The non-volatile storage medium stores an operating system and computer programs. The internal memory provides an environment for running of the operating system and the computer program in the non-volatile storage medium. The I/O interface of the computer device is configured for information exchange between the processor and an external device. The communication interface of the computer device is configured to communicate with an external terminal in a wired or wireless manner. The wireless manner may be implemented by WI-FI, a mobile cellular network, near field communication (NFC), or another technology. The computer program, when executed by the processor, implements an identity verification method. The display unit of the computer device is configured to form a visually visible screen, which may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, mouse, or the like.

It is noted that, the structure shown in FIG. 18 is only a block diagram of a part of a structure related to a solution of this disclosure and does not limit the computer device to which the solution of this disclosure is applied. In some aspects, the computer device may include more or fewer components than those in the drawings, or some components may be combined, or a different component deployment may be used.

In an embodiment, a computer device is further provided, including: a memory and a processor, the memory stores computer programs, and the computer program is executed by the processor to perform the steps of the foregoing method embodiments.

In an embodiment, a computer-readable storage medium is provided, having a computer program stored therein, the computer program, when executed by a processor, implementing the operations in the foregoing method embodiments.

In an embodiment, a computer program product is provided, including a computer program, the computer program, when executed by a processor, implementing the operations in the foregoing method embodiments.

User information (including, but not limited to, user equipment information, user personal information, and the like) and data (including, but not limited to, data for analysis, stored data, presented data, and the like) involved in this disclosure are all information and data authorized by users or fully authorized by all parties, and collection, use, and processing of relevant data need to comply with relevant laws, regulations, and standards of relevant countries and regions.

It is noted that all or some of procedures of the method in the foregoing embodiments may be implemented by a computer program instructing relevant hardware. The program may be stored in a non-volatile computer-readable storage medium. When the program is executed, the procedures of the foregoing method embodiments may be implemented. Any reference to a memory, a storage, a database, or other media used in the embodiments provided in this disclosure may include at least one of a non-volatile memory and a volatile memory. The non-volatile memory may include a read-only memory (ROM), a magnetic tape, a floppy disk, a flash memory, or an optical memory. The volatile memory may include a random access memory (RAM) or an external cache. By way of illustration and not limitation, RAM is available in many forms such as static random access memory (SRAM) or dynamic random access memory (DRAM).

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing disclosure includes some embodiments of this disclosure which are not intended to limit the scope of this disclosure. Other embodiments shall also fall within the scope of this disclosure.

What is claimed is:

1. A method for an identity verification, the method comprising:
acquiring one or more palm images that are captured based on a preset capturing field of view;
detecting respective palm key points in the one or more palm images, palm key points in a palm image of the one or more palm images being key points associated with a palm in the palm image;
determining respective palm directions of palms in the one or more palm images according to the respective palm key points associated with the palms in the one or more palm images;
determining respective calibration directions of the preset capturing field of view for the one or more palm images;
determining respective capturing angles of the palms in the one or more palm images according to the respective palm directions of the palms in the one or more palm images and the respective calibration directions in the one or more palm images;
selecting, from the one or more palm images, a target palm image whose capturing angle is within a preset capturing angle range, the preset capturing angle range being set to avoid the target palm image being from an incorrect participant of the identity verification; and
performing the identity verification according to the target palm image.

2. The method according to claim 1, wherein:
the determining the respective palm directions comprises:
constructing, for a first palm image in the one or more palm images when first palm key points of a first palm in the first palm image comprise a first palm key point and a second palm key point, a first vector according to the first palm key point and the second palm key point; and
using a direction of the first vector as a palm direction of the first palm in the first palm image.

3. The method according to claim 2, wherein:
the determining the respective calibration directions comprises:
constructing a second vector along a horizontal direction of the preset capturing field of view by using one of the first palm key point and the second palm key point as a starting point; and
using a direction of the second vector as a calibration direction of the preset capturing field of view in the first palm image.

4. The method according to claim 3, wherein:
the constructing the second vector comprises:
constructing, when the first palm in the first palm image is recognized to be a left palm, the second vector along a first horizontal direction; and
constructing, when the first palm in the first palm image is recognized to be a right palm, the second vector along a second horizontal direction, the first horizontal direction and the second horizontal direction being opposite horizontal directions.

5. The method according to claim 4, wherein:
the first horizontal direction is a positive direction of a horizontal axis of an image coordinate system of the first palm image; and
the second horizontal direction is a negative direction of the horizontal axis of the image coordinate system of the palm image.

6. The method according to claim 2, wherein:
the first palm key point is a finger gap point located between a ring finger and a little finger of the first palm in the first palm image; and
the second palm key point is a finger gap point located between an index finger and a middle finger of the first palm in the first palm image.

7. The method according to claim 1, wherein:
the acquiring the one or more palm images comprises:
acquiring at least an initial image that is captured with the preset capturing field of view;
extracting, for the initial image, an image feature of the initial image;
performing a palm detection based on the image feature of the initial image to obtain a palm region box of the initial image; and
cropping the initial image based on the palm region box to obtain a palm image from the initial image.

8. The method according to claim 7, wherein:
the palm region box is obtained according to a prediction by using a trained palm detection model; and the method further comprises:
acquiring a sample image, the sample image comprising a sample palm, and a reference palm region box that is calibrated for the sample palm;
performing palm detection on the sample image by using a to-be-trained palm detection model to obtain a predicted palm region box;
determining a target loss value according to at least one of a position difference, a width difference and a height difference between the predicted palm region box and the reference palm region box; and
adjusting parameters of the to-be-trained palm detection model according to at least the target loss value of the sample image to obtain the trained palm detection model.

9. The method according to claim 8, wherein:
the acquiring the sample image comprises:
acquiring an initial sample image;
dividing the initial sample image into a plurality of image blocks; and
calibrating at least one reference palm region box for each image block of the plurality of image blocks to obtain the sample image that includes a plurality of reference palm region boxes.

10. The method according to claim 8, wherein:
the sample image further carries a reference confidence of the reference palm region box; and
the determining the target loss value comprises:
determining a first loss value according to the position difference, the width difference and the height difference between the predicted palm region box and the reference palm region box;
determining a predicted confidence of the predicted palm region box according to a region overlap measure between the predicted palm region box and the reference palm region box, the region overlap measure and the predicted confidence being positively correlated;
determining a second loss value according to a confidence difference between the predicted confidence and the reference confidence; and
determining the target loss value based on the first loss value and the second loss value.

11. The method according to claim 10, wherein:
the determining the target loss value based on the first loss value and the second loss value comprises:
performing a category probability prediction on an object in the predicted palm region box by using the to-be-trained palm detection model to obtain a first palm category probability that the object being a palm;
determining a third loss value according to a difference between the first palm category probability of the object and a second palm category probability of the sample palm in the reference palm region box; and
determining the target loss value based on the first loss value, the second loss value, and the third loss value.

12. The method according to claim 1, wherein:
the detecting the respective palm key points comprises:
performing, for a palm image in the one or more palm images, a first feature extraction on the palm image to obtain an image feature of the palm image; and
performing a key point detection according to the image feature of the palm image to obtain palm key points of the palm image.

13. The method according to claim 12, wherein:
the performing the key point detection comprises:
performing an initial key point detection according to the image feature of the palm image to obtain initial key points of the palm image;
cropping, according to the initial key points, the palm image to obtain a cropped image that covers the initial key points and conforms to a preset size;
performing a second feature extraction on the cropped image to obtain an image feature of the cropped image, and
performing an additional key point detection according to the image feature of the cropped image to obtain the palm key points.

14. The method according to claim 1, further comprising:
performing a payment operation when the identity verification that is performed according to biological information in the target palm image is successful.

15. An apparatus for an identity verification, comprising processing circuitry configured to:
acquire one or more palm images that are captured based on a preset capturing field of view;
detect respective palm key points in the one or more palm images, palm key points in a palm image of the one or more palm images being key points associated with a palm in the palm image;
determine respective palm directions of palms in the one or more palm images according to the respective palm key points associated with the palms in the one or more palm images;
determine respective calibration directions of the preset capturing field of view for the one or more palm images;
determine respective capturing angles of the palms in the one or more palm images according to the respective palm directions of the palms in the one or more palm images and the respective calibration directions in the one or more palm images;
select, from the one or more palm images, a target palm image whose capturing angle is within a preset capturing angle range, the preset capturing angle range being set to avoid the target palm image being from an incorrect participant of the identity verification; and
perform the identity verification according to the target palm image.

16. The apparatus according to claim 15, wherein the processing circuitry is configured to:
construct, for a first palm image in the one or more palm images when first palm key points of a first palm in the first palm image comprise a first palm key point and a second palm key point, a first vector according to the first palm key point and the second palm key point; and
use a direction of the first vector as a palm direction of the first palm in the first palm image.

17. The apparatus according to claim 16, wherein the processing circuitry is configured to:
construct a second vector along a horizontal direction of the preset capturing field of view by using one of the first palm key point and the second palm key point as a starting point; and
use a direction of the second vector as a calibration direction of the preset capturing field of view in the first palm image.

18. The apparatus according to claim 17, wherein the processing circuitry is configured to:
construct, when the first palm in the first palm image is recognized to be a left palm, the second vector along a first horizontal direction; and
construct, when the first palm in the first palm image is recognized to be a right palm, the second vector along a second horizontal direction, the first horizontal direction and the second horizontal direction being opposite horizontal directions.

19. The apparatus according to claim 18, wherein:
the first horizontal direction is a positive direction of a horizontal axis of an image coordinate system of the first palm image; and
the second horizontal direction is a negative direction of the horizontal axis of the image coordinate system of the palm image.

20. A non-transitory computer-readable storage medium storing instructions which when executed by at least one processor cause the at least one processor to perform:
acquiring one or more palm images that are captured based on a preset capturing field of view;
detecting respective palm key points in the one or more palm images, palm key points in a palm image of the one or more palm images being key points associated with a palm in the palm image;
determining respective palm directions of palms in the one or more palm images according to the respective palm key points associated with the palms in the one or more palm images;
determining respective calibration directions of the preset capturing field of view for the one or more palm images;
determining respective capturing angles of the palms in the one or more palm images according to the respective palm directions of the palms in the one or more palm images and the respective calibration directions in the one or more palm images;
selecting, from the one or more palm images, a target palm image whose capturing angle is within a preset capturing angle range, the preset capturing angle range being set to avoid the target palm image being from an incorrect participant of an identity verification; and
performing the identity verification according to the target palm image.
